(19) United States
(12) Patent Application Publication
(10) Pub. No.: US 2024/0193124 A1
(43) Pub. Date: Jun. 13, 2024

(54) STORAGE SYSTEM AND METHOD FOR REDUCING OVERHEAD OF SNAPSHOT

(71) Applicant: SK hynix Inc., Gyeonggi-do (KR)

(72) Inventors: Jongryool KIM, San Jose, CA (US); Hyung Jin LIM, San Jose, CA (US); Timothy LO, San Jose, CA (US); Jaewoong LEE, San Jose, CA (US)

(21) Appl. No.: 18/078,574

(22) Filed: Dec. 9, 2022

(51) Int. Cl. G06F 16/11

(52) U.S. Cl. CPC G06F 16/128

(57) ABSTRACT

Embodiments of the present invention provide an architecture of a large-scale storage system supporting snapshot. The system includes a storage; and a storage system coupled to the server through a network. The storage system includes: at least one storage device coupled to the server through the network; and a computing component coupled between the storage device and the network and configured to: generate snapshot data based on data for backup, which is stored in the storage device; compact the snapshot data; and transfer, to the storage, the compacted snapshot data through a storage client interface for the storage.

### BACKGROUND

### 1. Field

Embodiments of the present disclosure relate to a scheme for storage systems.

### 2. Description of the Related Art

Recently, the use of computing devices (e.g., smartphones, portable computers and tablet computers) has precipitously increased. Further, it is now common for individuals and businesses to store massive quantities of data on local computing devices and/or on remote cloud-based storages.

Cloud storage is a service model in which data is transmitted and stored on remote storage systems through a cloud service provider (e.g., Amazon Web Services (AWS), Microsoft Azure). Reliability is increasingly important in large-scale storage systems. In this context, embodiments of the invention arise.

### SUMMARY

Aspects of the present invention include a system capable of increasing reliability in large-scale storage systems and a method thereof.

In one aspect of the present invention, a system includes a server, a storage, and a storage system coupled to the server through a network. The storage system includes: at least one storage device coupled to the server through the network; and a computing component coupled between the storage device and the network and configured to: generate snapshot data based on data for backup, which is stored in the storage device; compact the snapshot data; and transfer, to the storage, the compacted snapshot data through a storage client interface for the storage.

In another aspect of the present invention, a method for operating a system including a server, a storage and a storage system coupled to the server through a network, comprising: providing the storage system, which includes at least one storage device coupled to the server through the network, and a computing component coupled between the storage device; generating, by the computing component, snapshot data based on data for backup, which is stored in the storage device; compacting, by the computing component, the snapshot data; and transferring, by the computing component, to the storage, the compacted snapshot data through a storage client interface for the storage.

Additional aspects of the present invention will become apparent from the following description.

### BRIEF DESCRIPTION OF THE DRAWINGS

FIG. 1 is a block diagram illustrating a large-scale storage system.

FIG. 2 is a block diagram illustrating an example of a large-scale storage system.

FIG. 3 is a diagram illustrating a data search in a large-scale storage system.

FIG. 4 is a diagram illustrating a data search in a large-scale storage system in accordance with an embodiment of the present invention.

FIG. 5 is a diagram illustrating a large-scale storage system in accordance with an embodiment of the present invention.

FIGS. 6A to 6C illustrate computational storage systems in accordance with an embodiment of the present invention.

FIGS. 7A to 7E illustrate various structures of computational storage systems in accordance with an embodiment of the present invention.

FIG. 8 is a diagram illustrating a computing component in accordance with an embodiment of the present invention.

FIG. 9A illustrates a snapshot storing operation of a computing component in accordance with an embodiment of the present invention.

FIG. 9B illustrates NVMe commands in accordance with an embodiment of the present invention.

FIG. 9C illustrates a snapshot restoring operation of a computing component in accordance with an embodiment of the present invention.

FIG. 10 illustrates one implementation of a storage device including a computing component in accordance with an embodiment of the present invention.

FIG. 11A illustrate a structure for a snapshot storing operation of a computing component in accordance with an embodiment of the present invention.

FIG. 11B illustrates an example for an incremental snapshot operation in accordance with an embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure is thorough and complete, and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of embodiments of the present invention is provided below along with accompanying figures that illustrate aspects of the present invention. The present invention is described in connection with such embodiments, but the present invention is not limited to any embodiment. The scope of the present invention is limited only by the claims. The present invention encompasses numerous alternatives, modifications and equivalents within the scope of the claims. Numerous specific details are set forth in the following description in order to provide a thorough understanding of the present invention. These details are provided for the purpose of example; the present invention may be practiced according to the claims without some or all of these specific details. For clarity, technical material that is known in technical fields related to the present invention has not been described in detail so that the present invention is not unnecessarily obscured.

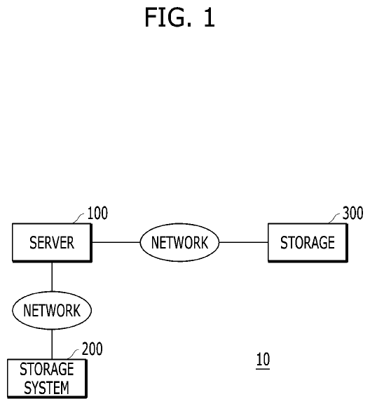

FIG. 1 is a block diagram illustrating a large-scale storage system 10.

Referring FIG. 1, the large-scale storage system 10 may include a server 100, a storage system 200 and a storage 300. Each of the storage system 200 and the storage 300 may be remotely coupled to the server 100 through a network. For example, the large-scale storage system 10 may be a cloud storage. Cloud storage is a service model in which data is transmitted and stored on remote storage systems through a cloud service provider (e.g., Amazon Web Services (AWS), Microsoft Azure).

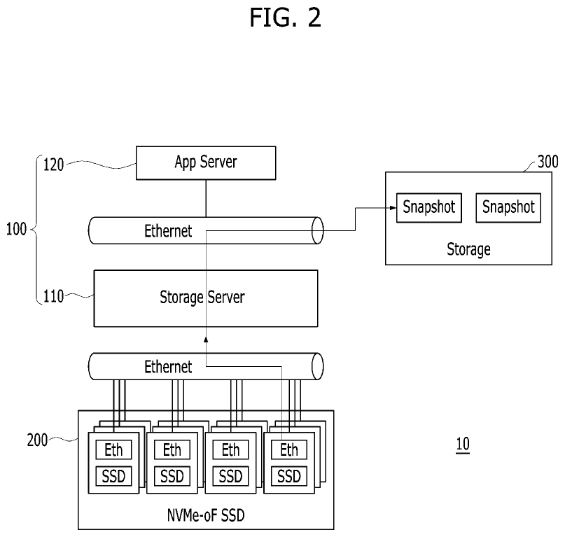

An example of the large-scale storage system 10 is shown in FIG. 2.

Referring FIG. 2, the server 100 may include a storage server 110 and an application (App) server 120. The storage system 200 may include a plurality of non-volatile memory (NVM) express over Fabrics (NVMe-oF) devices (e.g., non-volatile memory express (NVMe) solid state drives (SSDs)). NVMe-oF is a new industry standard defining a common architecture that supports an NVMe block storage protocol over a wide range of storage networking fabrics. The storage networking fabrics may be Ethernet (Eth) as shown in FIG. 2, Fibre Channel, InfiniBand (IB) or a transmission control protocol (TCP) or user datagram protocol (UDP) network. In one implementation, the storage system 200 may be implemented within a NVMe-OF JBOF (Just A Bunch Of NVMe Flash) enclosure.

Reliability is increasingly important in large-scale storage systems. In order to guarantee reliability of data, cloud service providers (CSPs) or storage solutions may back up data stored in NVMe SSDs in the storage (or backup storage, object storage, cold storage) 300 through snapshot function. Snapshots provide one mechanism for safeguarding data by creating a point-in-time copy of database contents. In one implementation, snapshot data may be block or page units of data. As shown in FIG. 2, snapshot may be performed to the storage 300 from a particular SSD of the storage system 200 through the computing server 110 and Ethernet. Thus, additional input/output (I/O) processing and computing overhead may be occurred.

Accordingly, embodiments of the present invention provide an architecture of a large-scale storage system supporting snapshot with reduced I/O processing and computing overhead. Embodiments may provide a computational SSD, which means a solid state drive (SSD) with a computation component or directly coupled to a computation component. The computational SSD may be coupled to a host (or server) through various interface such as PCIe, NVMe-oF and Ethernet. The SSD may provide, to the host, the computation result calculated by the computation component thereof so that I/O processing and computing overhead may be reduced.

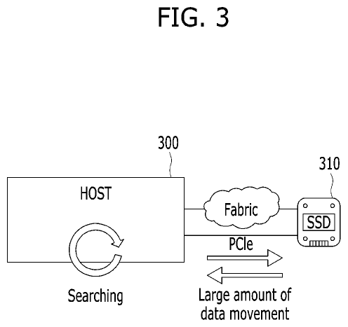

In an example of FIG. 3, a host (or server) 300 may perform a searching or scan operation for a specific character string from data stored in multiple SSDs 310 (e.g., several hundreds of SSDs). For the searching operation, the host 300 should read whole data from the multiple SSDs 310 and thus large amount of data is moved between the host 300 and SSDs 310.

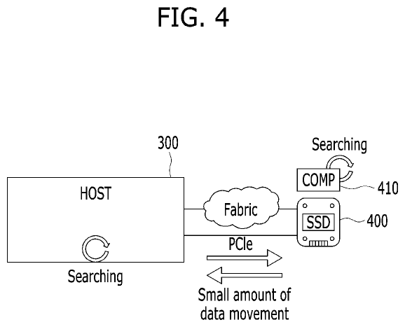

In order to reduce amount of data movement, embodiments of the present invention may provide a computational SSD. As shown in the illustrated embodiment of FIG. 4, each of multiple SSDs may be a computational SSD 400 with a computation component 410 or coupled to a computation component 410. In 20) accordance with the embodiment, the host 300 may provide, to the multiple SSDs 400, a command to search for a specific character string and each SSD may perform a searching operation in response to the command. Since each SSD provides the search result, small amount of data can be moved between the host 300 and SSDs 400.

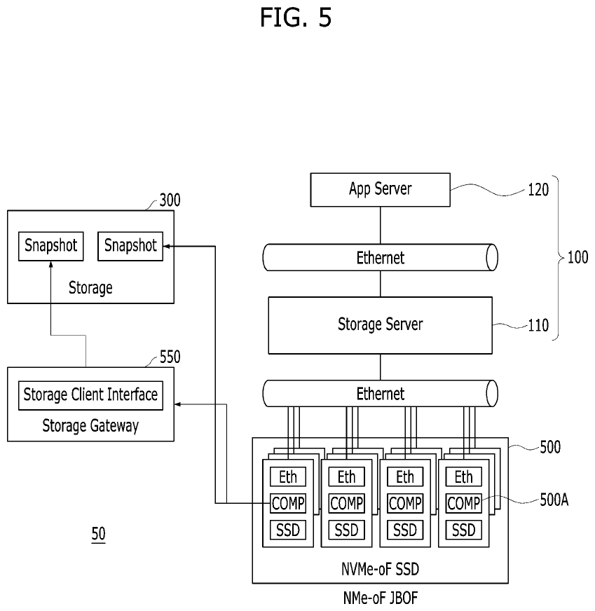

FIG. 5 is a diagram illustrating a large-scale storage system 50 in accordance with an embodiment of the present invention.

Referring FIG. 5, the large-scale storage system 50 may include a server 100, a storage system 500, a storage (or backup storage, object storage, cold storage) 300 and a storage gateway 550. The server 100 may include a storage server 110 and an application (App) server 120. In the illustrated embodiment, the computing server 110 and the application server 120 may be coupled through a particular network (or networking fabric) such as Ethernet. The application server 120 may use the computing server 110 and the storage 300. The application server 120 may correspond to a client of the computing server 110 and may use a client interface supporting an application programming interface (API) of a database (DB) of the computing server 110 or the storage 300.

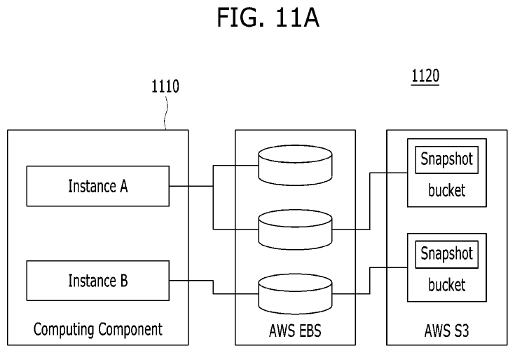

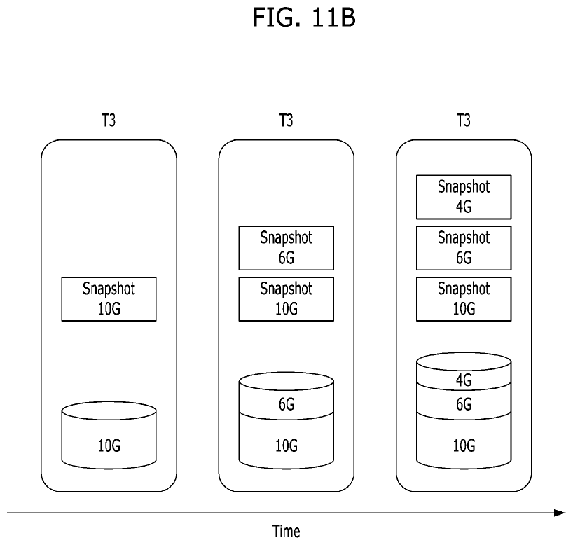

The storage 300 may be coupled to the server 100 through the network. In some embodiments, the storage 300 may be an object storage (or an object-based storage). The object storage may store block data associated with snapshot (i.e., backup data) as an object. Alternatively, the storage 300 may be an object storage based block storage or an object storage based file storage, which are recently developed by cloud service providers (CSPs). This embodiment is described with reference to FIG. 11A.

The storage system 500 may be coupled to the server 100 through the network. In some embodiments, the network may be Ethernet. In other embodiments, the network may be Fibre Channel, InfiniBand (IB) or a transmission control protocol (TCP) network. The storage gateway 550 may include a storage client interface (i.e., an application programming interface (API)) of the storage 300, which allows the connection between the storage system 500 and the storage 300 through the storage gateway 550.

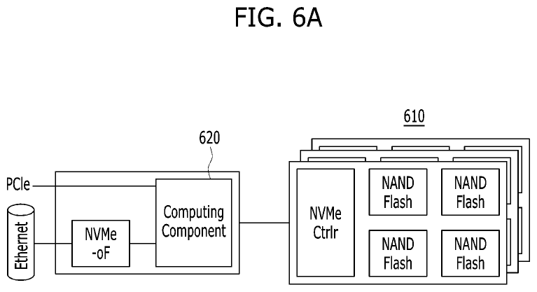

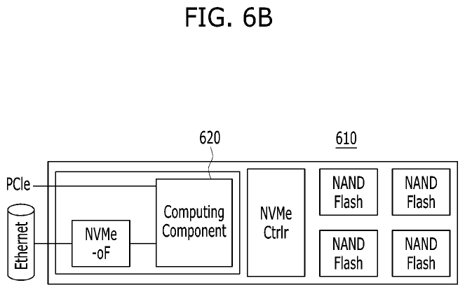

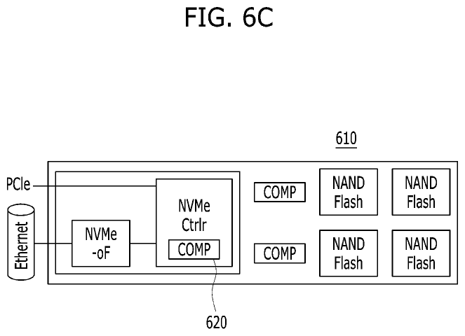

The storage system 500 may include a plurality of storage devices such as a plurality of non-volatile memory (NVM) express over Fabrics (NVMe-oF) devices. In one implementation, the plurality of NVMe-oF devices may be implemented within a NVMe-OF JBOF (Just A Bunch Of NVMe Flash) enclosure. Each NVMe-oF device may include a non-volatile memory express (NVMe) solid state drive (SSD). Further, each NVMe-oF device may include a computing component (COMP) 500A. In some embodiments, a NVMe SSD with the computing component 500A may be referred to as a computational SSD. Various 20) structures of the computational SSD are illustrated in FIGS. 6A to 6C.

Referring to FIGS. 6A to 6C, the computational SSD may include a solid state drive (SSD) 610 and a compute engine 620 as a computing component. The SSD 610 may include a controller (e.g., NVMe controller) and a plurality of memory devices (e.g., NAND flashes). The SSD 610 may be coupled to a server through the compute engine 620 and networks such as PCIe and Ethernet. The compute engine 620 may be coupled to Ethernet through NVMe-oF.

In the illustrated embodiment of FIG. 6A, the compute engine 620 may be directly attached (or coupled) to the SSD 610. In the illustrated embodiment of FIG. 6B, the SSD 610 and the compute engine 620 may be integrated as on-a-chip. In the illustrated embodiment of FIG. 6C, the compute engine 620 may be implemented within the SSD 610. For example, the compute engine 620 may be implemented within the NVMe controller of the SSD 610 and/or may be implemented between the NVMe controller and the plurality of NAND flashes.

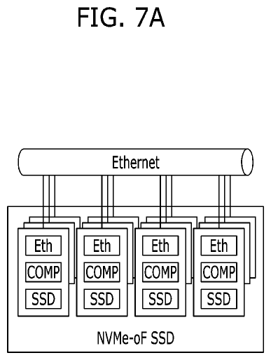

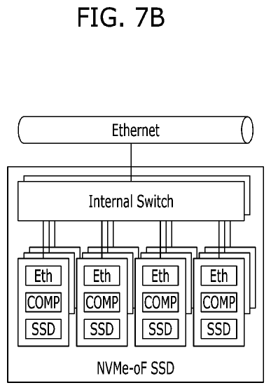

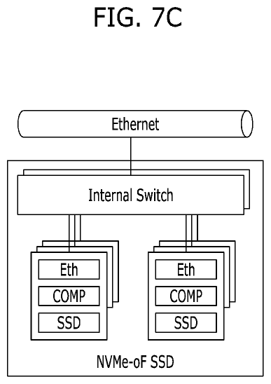

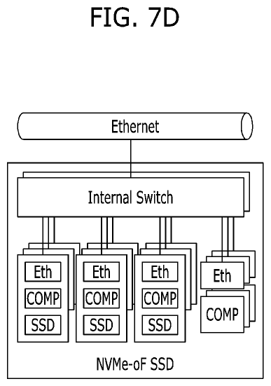

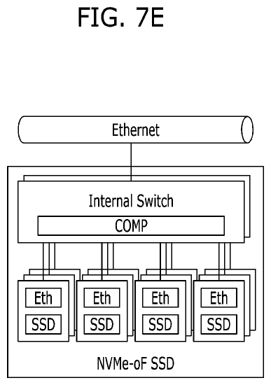

FIGS. 7A to 7E illustrate various structures of computational storage system in accordance with an embodiment of the present invention, e.g., the storage system 500 of FIG. 5.

FIGS. 7A to 7C illustrate the storage system including a computational storage (e.g., NVMe-OF SSD) with a computing component supporting computation and snapshot function in certified 20) scrum developers (CSD).

In FIG. 7A, a plurality of NVMe-OF devices may be implemented within a NVMe-OF JBOF enclosure. Each NVMe-OF device may include a NVMe SSD, a computing component (COMP) and an Ethernet component (Eth). The plurality of NVMe-OF devices may be coupled to Ethernet through Ethernet components thereof. In FIG. 7B, a plurality of NVMe-OF devices may be implemented within a NVMe-oF JBOF enclosure. Each NVMe-OF device may include a NVMe SSD, a computing component (COMP) and an Ethernet component (Eth). The plurality of NVMe-OF devices may be coupled to Ethernet through Ethernet components thereof and an internal switch for the NVMe-OF JBOF enclosure. In FIG. 7C, a plurality of NVMe-OF devices may be implemented within a NVMe-OF JBOF enclosure. Each NVMe-OF device may include two or more NVMe SSDs, a computing component (COMP) and an Ethernet component (Eth). The plurality of NVMe-OF devices may be coupled to Ethernet through Ethernet components thereof and an internal switch for the NVMe-OF JBOF enclosure.

FIGS. 7D and 7E illustrate the storage system including a computational storage (e.g., NVMe-oF SSD) with a computing component supporting computation and snapshot function in certified scrum professionals (CSP).

In FIG. 7D, a plurality of NVMe-OF devices may be implemented within a NVMe-OF JBOF enclosure. Each NVMe-oF device may include a NVMe SSD and an Ethernet component (Eth). Also, the NVMe-OF JBOF enclosure may include computing components (COMPs) corresponding to the plurality of NVMe-OF devices and Ethernet components. The plurality of NVMe-OF devices and computing components may be coupled to Ethernet through Ethernet components thereof and an internal switch for the NVMe-OF JBOF enclosure. In FIG. 7E, a plurality of NVMe-OF devices may be implemented within a NVMe-OF JBOF enclosure. Each NVMe-OF device may include a NVMe SSD and an Ethernet component (Eth). Also, the NVMe-OF JBOF enclosure may include an internal switch in which a computing component (COMP) may be implemented. The plurality of NVMe-OF devices may be coupled to the computing component of the internal switch through Ethernet components thereof and then may be coupled to Ethernet through the internal switch.

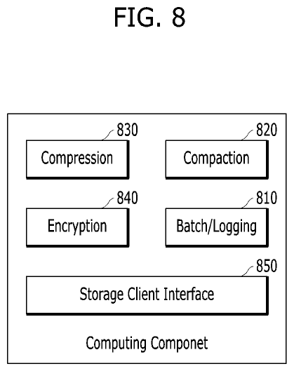

FIG. 8 is a diagram illustrating a computing component in accordance with an embodiment of the present invention. For example, the computing component may be the computing component 500A of the storage device in FIG. 5.

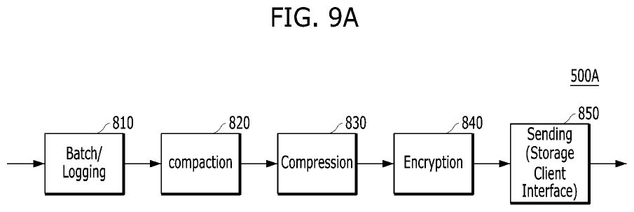

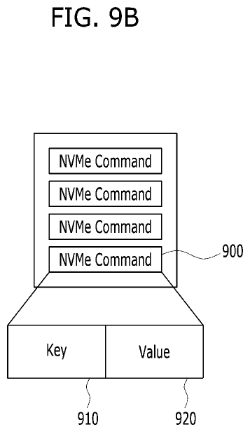

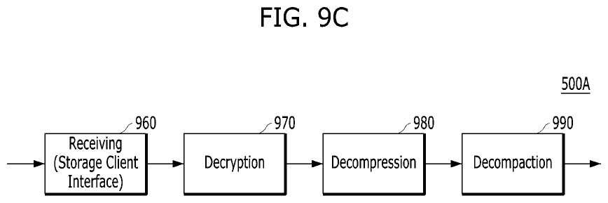

Referring FIG. 8, the computing component 500A may include a batch and logging component 810, a compaction component 820, a compression component 830, an encryption component 840 and a storage client interface for sending 850. With these components, the computing component 500A may support a backup data pipeline as shown in FIG. 9A. That is, the computing component 500A may provide snapshot data stored in a storage device (e.g., SSD in FIG. 5) to a storage (e.g., the storage 300 of the storage system 500 in FIG. 5). Although FIG. 8 shows that the backup data pipeline includes all components shown therein, the backup data pipeline may be implemented with two or more components including the storage client interface 850 and one or more other components.

In some embodiments, snapshot function (i.e., data backup) may be performed when a set backup condition satisfies. For example, the backup condition may be a set time, a set data size and set request counts (i.e., a number of commands). In other embodiments, snapshot function may be performed in response to a particular backup command. For example, the backup command may be associated with an application programming interface (API) call from a user through an SSD device driver.

Referring to FIGS. 8 and 9A, the computing component 500A may generate snapshot data based on data for backup, which is stored in the storage device, compact (or compress, encrypt) the snapshot data, and transfer, to the storage 300, the compacted snapshot data.

The batch and logging component 810 may log particular data from the storage device. In some embodiments, the particular data may include NVMe input and output (I/O) commands. Each NVMe I/O command may include capsulation of a particular command and data associated with the particular command. In some embodiments, each command may be associated with one of insert, update and delete commands. Snapshot data backup should be operated such that changed portions of data should be kept during the data backup. Thus, data associated with a read command may be backed up without any processing. In contrast, data associated with insert, update or delete commands should be processed by the batch and logging component 810. Then, the data associated with insert, update or delete commands may be back up at the same time when a particular condition satisfies. The particular condition is described below.

The batch and logging component 810 may batch the NVMe I/O commands based on set batching criteria to generate one or more batch command sets. In some embodiments, the set batching criteria includes one of time, data size and request counts.

The batch and logging component 810 may allocate an identifier to each batch command set, and generate the snapshot data including multiple command sets when a set particular condition satisfies. In some embodiments, the set particular condition includes one of a set time, a set data size and a set request count. For example, data backup may be performed at the set time (e.g., 1 hour) after a previous backup. Herein, the data to be backed up may be data reflecting data which is changed (i.e., inserted, updated or deleted) during the set time after the previous backup. For another example, data backup may be performed when a requested data size is greater than the set data size (e.g., 10 GB). For another example, data backup may be performed when a number of requests is greater than the set request count (e.g., 100)

In some embodiments, each batch command set includes a key as the identifier and a value of each batch command set. In the illustrated example of FIG. 9B, NVMe I/O commands are batched based on set batching criteria to generate one or more batch command sets. Each NVMe command 900 may include a key 910 and a value 920. In some embodiments, the key 910 may be an identifier SnapshotID, which includes an identifier of the storage device (e.g., SSDID) and a value of date (e.g., date serial value). In some embodiments, the value 920 may be snapshot data. For example, the value 920 may be user data transferred with insert or update commands (or requests). As for a delete command, only the key 910 may be included in the NVMe command 900.

The compaction component 820 may compact snapshot data. In some embodiments, the compaction component 820 may compact snapshot data (e.g., NVMe commands) with the same address (e.g., a logical block address (LBA)) to reduce the amount of data to be transmitted. NVMe commands may be managed using a bloom filter 20) according to LBAs thereof. The management result may indicate ‘hit’. This instance indicates that the same LBA has been changed. For this instance, the compaction component 820 may compact NVMe commands by deleting the previous command and instead keeping the current command.

The compression component 830 may compress snapshot data. In some embodiments, the compression component 830 may compress snapshot data (e.g., NVMe commands) with a particular data compression algorithm.

The encryption component 840 may encrypt snapshot data. In some embodiments, the encryption component 840 may encrypt snapshot data (e.g., NVMe commands) with a particular data compression algorithm (e.g., Advanced Encryption Standard with Galois Counter Mode (AES-GCM), Advanced Encryption Standard with Electronic Code Book (AES-ECB).

The storage client interface 850 may transfer snapshot data to the storage 300. In some embodiments, the transferred snapshot data may be compacted (or compressed, encrypted) snapshot data. In order to store the snapshot (or backup) data in the storage 300, the storage client interface 850 may be a client interface compatible with the storage 300. For example, when the storage 300 supports a particular client interface, connection with the storage 300 may be managed and backup data storing function (e.g., the pipeline shown FIG. 9A) and/or restoring function (e.g., the pipeline shown FIG. 9C) may be performed through the particular client interface 850. For example, when the storage 300 supports a restful API, the storage client interface 850 may use the restful API.

In some embodiments, the storage client interface 850 may transfer the snapshot data through the storage gateway 550 when a connection pool between the storage device (e.g., SSD) and the storage 300 is usable. The connection pool may represent a plurality of connections. One or more connections may be created and the created and used connections may be deleted. In an embodiment, for improvement of performance, a set number of connections may be determined and used. In order to use connections, information of TCP/UDP socket corresponding to the connections may be resided in a memory. The connection pool may be determined according to an allowable usage of the memory. In an embodiment, when the allowable usage is low, the storage client interface 850 may additionally create one or more connections between the storage device (e.g., SSD) and the storage 300 through the storage gateway 550. In an embodiment, when the allowable usage is high, the storage client interface 850 may use one or more connections among the connection pool through the storage gateway 550. In some embodiments, the 20) storage client interface 850 may allow one or more connections between the SSD and the storage 300 through the storage gateway 550 by using a storage client interface (i.e., an application programming interface (API)) of the storage 300.

FIG. 9C illustrates a snapshot restoring operation of a computing component in accordance with an embodiment of the present invention. For example, the computing component may be the computing component 500A of the storage device in FIG. 5.

Referring FIG. 9C, in addition to components 810 to 850, shown in FIG. 8, the computing component 500A may include a storage client interface for receiving 960, a decryption component 970, a decompression component 980 and a decompaction component 990. The components of FIG. 9C may support a snapshot restoring operation. That is, the computing component 500A may receive snapshot data stored in a storage (e.g., the storage 300 of the storage system 500 in FIG. 5) and restore the read snapshot data.

The components of FIG. 9C may support a snapshot restoring pipeline, which is opposed to a backup data pipeline as shown in FIG. 9A. The storage client interface 960 may receive, through the storage gateway 550, snapshot data stored in the storage 300 of the storage system 500. The decryption component 970 may decrypt the received snapshot data. The decompression component 980 may decompress the decrypted snapshot data. The decompaction component 990 may decompact the decompressed snapshot data. Although FIG. 9C shows that the snapshot restoring pipeline includes all components shown therein, the snapshot restoring pipeline may be implemented with two or more components including the storage client interface 960 and one or more other components.

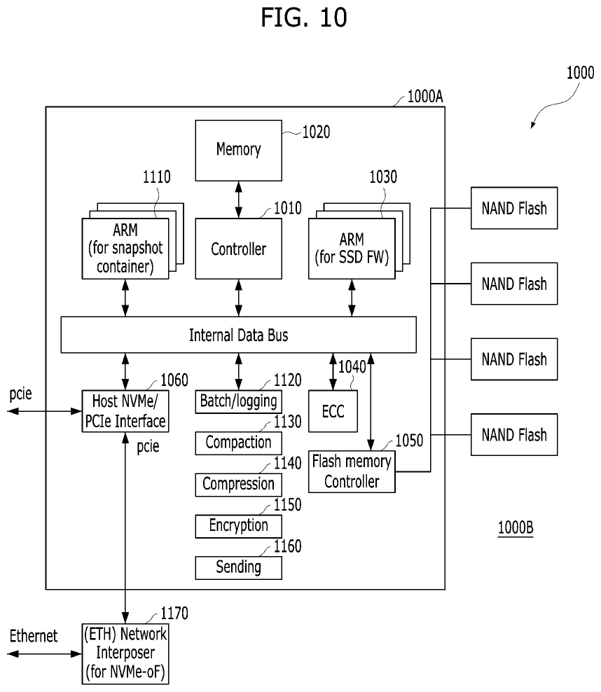

FIG. 10 illustrates one implementation of a storage device 1000 including a computing component in accordance with an embodiment of the present invention. For example, the storage device 100 may correspond to the storage device 500 (e.g., SSD) in FIG. 5.

Referring FIG. 10, the storage device 1000 may include a controller 1000A and a plurality of NAND flash memory devices 1000B. The controller 1000A may be implemented with a combination of an application (i.e., ARM) and a hardware (i.e., FPGA or ASIC). The controller 1000A may include a memory controller 1010, a memory 1020, an application for SSD firmware (FW) 1030, an error correction code (ECC) circuit 1040, a flash memory controller 1050 and an NVMe/PCIe interface 1060. The application for SSD FW 1030 may include a flash translation layer (FTL). These components may be components for typical SSD. Further, the controller 1000A may include components for snapshot function in accordance with an embodiment of the present invention, i.e., an application for snapshot function 1110. That is, FIG. 10 illustrates that the controller 1000A is implemented with components for the typical SSD and the snapshot function in one chip.

The application 1110 may operate a light weight operating system (OS) and various functions associated with snapshot may be operated in a form of container. In some embodiments, a batch/logging function (or container) 1120, a compact function 1130, a compression function 1140, an encryption function 1150 and a sending function 1160 may be operated. The batch/logging function 1120, the compaction function 1130, the compression function 1140 and the encryption function 1150 may perform operations corresponding to the batch/logging component 810, the compaction component 820, the compression component 830 and the encryption component 840 in FIG. 8, respectively. In some embodiments, the functions 1110 to 1160 may be performed according to a micro service architecture. That is, the batch/logging function 1120 is operated, the compaction function 1130 is operated when a particular batching condition satisfies, and then the compression function 1140 and the encryption function 1150 are operated. Finally, the sending function 1160 may send snapshot data to the storage 300 by using a storage client interface (i.e., application programming interface (API)) of the storage 300 through the storage gateway 550, as shown in FIG. 5.

In some embodiments, the snapshot function (or backup) may be triggered when a particular user request is received or a 20) particular condition satisfy. When the snapshot function is triggered, all NVMe commands may be transferred to the plurality of NAND flash memory devices 1000B through the application for SSD FW 1030. Before the NVMe commands are transferred to the application for SSD FW 1030, the NVMe commands may be intercepted by the application for snapshot function 1110, and NVMe commands to be included for snapshot may be separately stored and may be used for snapshot, i.e., may be backup. After the backup, the separately stored NVMe commands may be deleted.

The controller 1000A of the storage device 1000 may include a network interposer 1170 as an Ethernet interface. The storage device 1000 with the network interposer 1170 may be a NVMe—of SSD or a NVMe over Ethernet. The network interposer 1170 may have two functions: a function to process a typical network protocol such as a transmission control protocol/internet protocol (TCP/IP) or user datagram protocol (UDP) and a function to process one or more NVMe commands. Thus, the server (or host) 100 of FIG. 5 may use and control the storage device (e.g., SSD) 1000 under the assumption that the storage device 1000 is in local. Specifically, the NVMe command of the server 100 may be reached out to the network interposer 1170 through a network interface card (NIC) of the server 100. The network interposer 1170 may process one or more network packets, and then may process the NVMe commands under control of the controller 1000A and may transfer to the server 100 the processing result of the NVMe commands. In addition to these processing, the controller 1000A may perform functions such as compression/decompression, checksum to be necessary for a write pipeline.

One of a plurality of NVMe—of SSDs may be searched. The plurality of NVMe—of SSDs may be implemented within an enclosure such as a JBoF, which provides power and a health check for SSDs enclosed therein. The NVMe/PCIe interface 1060 may be provided with the power and may be used for a status check (On/Off).

FIG. 11A illustrates a structure for a snapshot storing operation of a computing component in accordance with an embodiment of the present invention. In some embodiments, the computing component may store a volume snapshot in a storage. The storage may be an object storage, which stores block data associated with snapshot (i.e., backup data) as a unit of an object (e.g., 320 KB).

In other embodiments, the storage may be an object storage based block storage or an object storage based file storage 1120, which are recently developed by cloud service providers (CSPs). For example, the storage 1120 may include an Amazon Elastic Block Store (AWS EBS) as a block storage and an Amazon Simple Cloud Storage (AWS S3) as an object storage. When a request to use the block storage is received, a computing component 1110 (or the application server 120 of FIG. 5)) may change the received request to a request to the object storage, and may store, in the object storage, block data in response to the received request. For example, when 5 write requests is received in a block interface for the block storage and each request corresponds to 64 KB, an object with the size of 5*64 KB may be stored in the object storage. For Azure, a volume snapshot may be stored as an extra volume.

FIG. 11B illustrates an example for an incremental snapshot operation in accordance with an embodiment of the present invention. Referring to FIG. 11B, at T1, snapshot data (e.g., 10Gbyte) may be stored. At T2, the differential data (e.g., 6Gbyte) from the snapshot data at T1 may be stored. At T3, the differential data (e.g., 4Gbyte) from the snapshot data at T2 is stored. That is, the incremental snapshot operation may be performed as shown in FIG. 11B.

As described above, embodiments provide a scheme for an architecture of a large-scale storage system supporting snapshot with reduced I/O processing and computing overhead by using a computational SSD. Thus, embodiments may reduce I/O processing and computing overhead.

Although the foregoing embodiments have been illustrated and described in some detail for purposes of clarity and understanding, the present invention is not limited to the details 20) provided. There are many alternative ways of implementing the invention, as one skilled in the art will appreciate in light of the foregoing disclosure. The disclosed embodiments are thus illustrative, not restrictive. The present invention is intended to embrace all modifications and alternatives that fall within the scope of the claims. Furthermore, the embodiments may be combined to form additional embodiments.

1. A system comprising:
a server;
a storage; and
a storage system remotely coupled to the server through a network,
wherein the storage system includes:
at least one storage device remotely coupled to the server through the network; and
a computing component coupled between the storage device and the network and configured to:
generate snapshot data based on data for backup, which is stored in the storage device;
compact the snapshot data to generate compacted snapshot data of the data which is stored in the storage device; and
transfer, to the storage, the compacted snapshot data through a storage client interface for the storage,
wherein the storage system including the at least one storage device remotely coupled to the server is cloud based.

2. The system of claim 1, wherein the storage device includes a non-volatile memory express (NVMe) over Fabrics (NVMe-oF) solid state drive (SSD).

3. The system of claim 1, wherein the network includes Ethernet.

4. The system of claim 1, wherein the storage includes an object storage.

5. The system of claim 1, wherein the computing component is further configured to: selectively perform at least one of compression and encryption for the compacted snapshot data.

6. The system of claim 1, wherein the data for backup includes NVMe commands, each associated with one of insert, update and delete commands.

7. The system of claim 6, wherein each NVMe command includes capsulation of a particular command and data associated with the particular command.

8. The system of claim 7, wherein the computing component generates the snapshot data by:
batching the NVMe commands based on set batching criteria to generate one or more batch command sets;
allocating an identifier to each batch command set; and
generating the snapshot data including multiple command sets, each command set including a key as the identifier and a value of each batch command set when a set condition satisfies.

9. The system of claim 8, wherein the set batching criteria includes one of time, data size and request counts,
wherein the condition includes one of a set time, a set data size and a set request count, and
wherein the multiple command sets include multiple batch command sets corresponding to the set condition.

10. The system of claim 8, wherein the computing component allocates the identifier based on an identifier of the storage device and a value of date.

11. A method for operating a system including a server, a storage and a storage system remotely coupled to the server through a network, comprising:
providing the storage system, which includes at least one storage device remotely coupled to the server through the network, and a computing component coupled between the storage device and the network;
generating, by the computing component, snapshot data based on data for backup, which is stored in the storage device;
compacting, by the computing component, the snapshot data to generate compacted snapshot data of the data which is stored in the storage device; and
transferring, by the computing component, to the storage, the compacted snapshot data through a storage client interface for the storage,
wherein the storage system including the at least one storage device remotely coupled to the server is cloud based.

12. The method of claim 11, wherein the storage device includes a non-volatile memory express (NVMe) over Fabrics (NVMe-oF) solid state drive (SSD).

13. The method of claim 11, wherein the network includes Ethernet.

14. The method of claim 11, wherein the storage includes an object storage.

15. The method of claim 11, further comprising:
selectively performing at least one of compression and encryption for the compacted snapshot data.

16. The method of claim 11, wherein the data for backup includes NVMe commands, each associated with one of insert, update and delete commands.

17. The method of claim 16, wherein each NVMe command includes capsulation of a particular command and data associated with the particular command.

18. The method of claim 17, wherein the generating of the snapshot data includes:
batching the NVMe commands based on set batching criteria to generate one or more batch command sets;
allocating an identifier to each batch command set; and
generating the snapshot data including multiple command sets, each command set including a key as the identifier and a value of each batch command set when a set condition satisfies.

19. The method of claim 18, wherein the set batching criteria includes one of time, data size and request counts,
wherein the condition includes one of a set time, a set data size and a set request count, and
wherein the multiple command sets include multiple batch command sets corresponding to the set condition.

20. The method of claim 18, wherein the allocating includes allocating the identifier based on an identifier of the storage device and a value of date.

21. A system comprising:
a server;
a storage; and
a storage system remotely coupled to the server through a network,
wherein the storage system includes:
at least one storage device remotely coupled to the server through the network; and
a computing component coupled to the storage device and the network, and configured to:
generate snapshot data based on data for backup, which is stored in the storage device;
compact the snapshot data to generate compacted snapshot data of the data which is stored in the storage device; and
transfer, to the storage, the compacted snapshot data through a storage client interface for the storage,
wherein the storage system including the at least one storage device remotely coupled to the server is cloud based.
